(19) United States
(12) Patent Application Publication
(10) Pub. No.: US 2024/0282174 A1
(43) Pub. Date: Aug. 22, 2024

(54) SERVICE PROVIDING SERVER FOR PROVIDING THE GAME SERVICE THAT SUPPORTS PARTICIPATION IN A TOURNAMENT FOR A GAME USING A TICKET AND THAT GIVES THE CUSTOMIZED SCORE ACCORDING TO THE RECORD ABOUT THE MEMBER WHO PARTICIPATED IN THE TOURNAMENT, AND THE OPERATING METHOD THEREOF

(71) Applicant: Supertree Co., Ltd., Seoul (KR)

(72) Inventor: Sung Wone CHOI, Seoul (KR)

(73) Assignee: Supertree Co., Ltd., Seoul (KR)

(21) Appl. No.: 18/432,026

(22) Filed: Feb. 4, 2024

(30) Foreign Application Priority Data
Feb. 21, 2023 (KR) 10-2023-0022779

(51) Int. Cl. G07F 17/32

(52) U.S. Cl. CPC G07F 17/3276; G07F 17/3237; G07F 17/3244

(57) ABSTRACT

Disclosed are a service providing server for providing a game service that supports participation in tournaments for games using tickets and gives a customized score according to the record for the member who participates in the tournament, and an operating method thereof to allow members to enjoy the games together with other members in an online environment while competing with each other in a tournament scheme, and allow the member who participates in the tournament to receive an optimal score according to the record thereof.

### CROSS-REFERENCE TO RELATED APPLICATIONS

This application claims priority to and the benefit of Korean Patent Application No. 10-2023-0022779 filed in the Korean Intellectual Property Office on Feb. 21, 2023, the entire contents of which are incorporated herein by reference.

### TECHNICAL FIELD

The present disclosure relates to a service providing server for providing the game service that supports participation in a tournament for a game using a ticket and that gives the customized score according to the record about the member who participated in the tournament, and an operating method thereof.

### BACKGROUND ART

Recently, as various electronic terminals including desktop PCs, smart phones, tablet PCs, console game machines, etc., have been released, the number of persons who play games through the electronic terminals has increased.

In particular, the recent electronic terminals provide an environment which enables playing games with others online, in that the electronic terminals enable online connections, and as such an environment is widely distributed, an interest in introduction of a new business model using an online based game is also increasing.

For example, by holding a tournament competition using a number of games so that people participate in the tournament of the game they want, the introduction of a business model that pays a certain reward to a person who reaches a specific reward reference score can be considered.

However, in order to provide a tournament platform service using these games, user management technology needs to be introduced, which does not allow anybody to participate in the tournament, but allows only the users who qualify for participating in a predetermined tournament to participate in the tournament to improve the quality of the service.

Further, there is also a need of introducing technology that calculates scores according to records of respective persons who participate in the tournament, and when the calculated score reaches the specific reward reference score, pays a predetermined reward to cause an interest in the tournament, for activation of the tournament platform service. However, there is a need of considering introduction of a service that calculates and assigns a score customized for each participant by considering a game skill of each participant or a difficulty of each game when giving scores according to records to tournament participants in that game skills of tournament participants may be different from each other, and difficulties of respective games may be different from each other.

In this regard, the introduction of service technology can be considered, which allows only predetermined certified members to participate in the tournament, and at the same time, issues a predetermined ticket for participating in the tournament, and allows only the people who purchase this ticket to participate in the tournament of a specific game and can calculate, with respect to the member who participates in the tournament, a customized score according to the record of the member.

### SUMMARY OF THE INVENTION

The present disclosure has been made in an effort to provide a service providing server for providing a game service that supports participation in tournaments for games using tickets and gives a customized score according to the record for the member who participates in the tournament, and an operating method thereof to allow members to enjoy the games together with other members in an online environment while competing with each other in a tournament scheme, and support the member who participates in the tournament to receive an optimal score according to the record thereof.

An exemplary embodiment of the present disclosure provides a service providing server for providing the game service that supports participation in a tournament for a game using a ticket and that gives the customized score according to the record about the member who participated in the tournament, which includes: a ticket number information storage unit storing information on the number of required tickets for participating in tournaments of a plurality of predetermined respective games; a game score information storage unit storing information on a predetermined game score corresponding to each of the plurality of games, wherein the game score of each of the plurality of games means a score given to a winner when winning a battle for each game; a ticket quantity information storage unit storing information on the quantity of holding tickets held by each of a plurality of members which subscribes to the game service; a record score information storage unit storing information on a record score corresponding to each of the plurality of members, wherein the record score of each of the plurality of members means a score calculated according to the game record of each member; when an access request command to a tournament session, wherein the tournament session means a session opened for allowing members accessing the tournament session through the client terminal to play the first game online jointly, opened for a first game which is any one of the plurality of games is received from a first client terminal held by a first member which is any one of the plurality of members, a confirmation unit conducting certification for the first member, and then confirming a first required number which is the number of required tickets for participating in the tournament of the first game by referring to the ticket number information storage unit, and confirming the quantity of holding tickets held by the first member by referring to the ticket quantity information storage unit; a reduction processing unit allowing, when it is confirmed that the quantity of holding tickets held by the first member is equal to or more than the first required number, the first client terminal to access the tournament session, and then reducing the quantity of holding tickets held by the first member stored in the ticket quantity information storage unit by the first required number; an update event generation unit generating an update event for updating the record score of the first member when it is determined that the first member wins according to a result in which the first member matches a second member who accesses the tournament session, and performs the battle for the first game after the access of the first client terminal to the tournament session is permitted; a record score update unit updating a first record score for the first member stored in the record score information storage unit based on a first game score corresponding to the first game stored in the game score information storage unit when the update event is generated; and a record score transmission unit transmitting, when the first record score is updated, information on the updated first record score to the first client terminal.

Further, another exemplary embodiment of the present disclosure provides an operating method of a service providing server for providing the game service that supports participation in a tournament for a game using a ticket and that gives the customized score according to the record about the member who participated in the tournament, which includes: maintaining a ticket number information storage unit storing information on the number of required tickets for participating in tournaments of a plurality of predetermined respective games; maintaining a game score information storage unit storing information on a predetermined game score corresponding to each of the plurality of games, wherein the game score of each of the plurality of games means a score given to a winner when winning a battle for each game; maintaining a ticket quantity information storage unit storing information on the quantity of holding tickets held by each of a plurality of members which subscribes in the game service; maintaining a record score information storage unit storing information on a record score corresponding to each of the plurality of members, wherein the record score of each of the plurality of members means a score calculated according to the game record of each member; when an access request command to a tournament session, wherein the tournament session means a session opened for allowing members accessing the tournament session through the client terminal to play the first game online jointly, opened for a first game which is any one of the plurality of games is received from a first client terminal held by a first member which is any one of the plurality of members, conducting certification for the first member, and then confirming a first required number which is the number of required tickets for participating in the tournament of the first game by referring to the ticket number information storage unit, and confirming the quantity of holding tickets held by the first member by referring to the ticket quantity information storage unit; allowing, when it is confirmed that the quantity of holding tickets held by the first member is equal to or more than the first required number, the first client terminal to access the tournament session, and then reducing the quantity of holding tickets held by the first member stored in the ticket quantity information storage unit by the first required number; generating an update event for updating the record score of the first member when it is determined that the first member wins according to a result in which the first member matches a second member who accesses the tournament session, and performs the battle for the first game after the access of the first client terminal to the tournament session is permitted; updating a first record score for the first member stored in the record score information storage unit based on a first game score corresponding to the first game stored in the game score information storage unit when the update event is generated; and transmitting, when the first record score is updated, information on the updated first record score to the first client terminal.

According to an exemplary embodiment of the present disclosure, a service providing server for providing a game service that supports participation in tournaments for games using tickets and gives a customized score according to the record for the member who participates in the tournament, and an operating method thereof are provided to allow members to enjoy the games together with other members in an online environment while competing with each other in a tournament scheme, and support the member who participates in the tournament to receive an optimal score according to the record thereof.

### BRIEF DESCRIPTION OF THE DRAWINGS

FIG. 1 is a diagram illustrating a structure of a service providing server for providing the game service that supports participation in a tournament for a game using a ticket and that gives the customized score according to the record about the member who participated in the tournament according to an exemplary embodiment of the present disclosure.

FIG. 2 is a diagram for describing an operation of a service providing server for providing the game service that supports participation in a tournament for a game using a ticket and that gives the customized score according to the record about the member who participated in the tournament according to an exemplary embodiment of the present disclosure.

FIG. 3 is a flowchart illustrating an operating method of a service providing server for providing the game service that supports participation in a tournament for a game using a ticket and that gives the customized score according to the record about the member who participated in the tournament according to an exemplary embodiment of the present disclosure.

### DETAILED DESCRIPTION

Hereinafter, exemplary embodiments of the present disclosure will be described in detail with reference to the accompanying drawings. The description does not limit the present disclosure to specific exemplary embodiments, and it should be understood that the present disclosure covers all the modifications, equivalents and replacements included within the idea and technical scope of the present disclosure. In describing each drawing, like reference numerals refer to like elements and if not contrarily defined, all terms used herein including technological or scientific terms have the same meanings as those generally understood by a person with ordinary skill in the art.

In this document, unless explicitly described to the contrary, the word “comprise” and variations such as “comprises” or “comprising”, will be understood to imply the inclusion of stated elements but not the exclusion of any other elements. Further, in various exemplary embodiments of the present disclosure, each of the components, functional blocks or means may be constituted by one or more lower components and electrical, electronic, and mechanical functions performed by respective components may be implemented as various known devices or mechanical elements including an electronic circuit, an integrated circuit, an Application Specific Integrated Circuit (ASIC), etc., and the respective components may be separately implemented or two or more components may be integrated into one and implemented.

Meanwhile, blocks of the accompanying block diagram or steps of a flowchart may be appreciated as meaning computer program commands mounted on a processor or a memory of data processible equipment such as a universal computer, a special computer, a portable notebook computer, a network computer, etc., and performing designated functions. Since the computer program commands may be stored in a memory provided in a computer device or a computer readable memory, functions described in blocks of a block diagram or steps of a flowchart may be produced as a manufactured object including an instruction mean performing the functions. Moreover, each block or each step may represent a part of a module, a segment, or a code that includes one or more executable instructions for executing a specified logical function(s). It should also be noted that in some replaceable embodiments, the functions mentioned in the blocks or steps may also be executed differently from a predetermined order. For example, two blocks or steps that are subsequently illustrated are substantially simultaneously carried out, or may be performed in a reverse order, and in some cases, the functions may be performed while some blocks or steps are omitted.

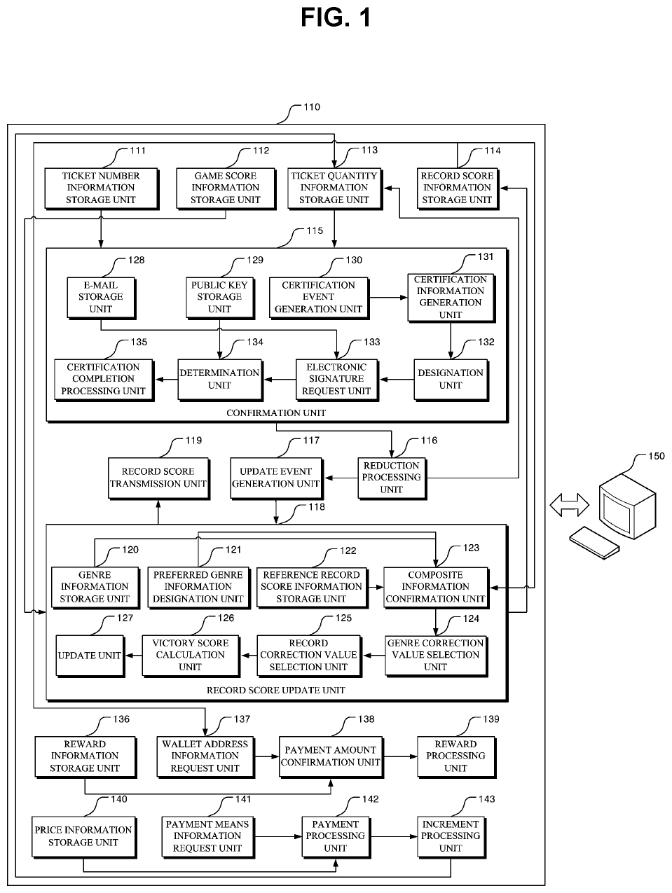

FIG. 1 is a diagram illustrating a structure of a service providing server for providing the game service that supports participation in a tournament for a game using a ticket and that gives the customized score according to the record about the member who participated in the tournament according to an exemplary embodiment of the present disclosure.

Referring to FIG. 1, the service providing server 110 according to the present disclosure may include a ticket number information storage unit 111, a game score information storage unit 112, a ticket quantity information storage unit 113, a record score information storage unit 114, a confirmation unit 115, a reduction processing unit 116, an update event generation unit 117, a record score update unit 118, and a record score transmission unit 119.

The ticket number information storage unit 111 stores information on the number of required tickets for participating in tournaments of a plurality of predetermined respective games.

For example, the ticket number information storage unit 111 may store information shown in Table 1 below.

TABLE 1

| Plurality | Number of |
|---|---|
| of games | required tickets |
| Game 1 | 2 |
| Game 2 | 1 |
| Game 3 | 5 |
| Game 4 | 7 |
| . . . | . . . |

The game score information storage unit 112 stores information on a predetermined game score corresponding to each of the plurality of games (the game score of each of the plurality of games means a score given to a winner when winning a battle for each game).

For example, the game score information storage unit 112 may store information shown in Table 2 below.

TABLE 2

| Plurality | | |
|---|---|---|
| of games | Game score | |
| Game 1 | 9 | points |
| Game 2 | 8 | points |
| Game 3 | 10 | points |
| Game 4 | 15 | points |

| | |
|---|---|
| . . . | . . . |

The ticket quantity information storage unit 113 stores information on the quantity of holding tickets held by each of a plurality of members which subscribes to the game service.

For example, the ticket quantity information storage unit 113 may store information shown in Table 3 below.

TABLE 3

| Plurality | Quantity of |
|---|---|
| of members | holding tickets |
| Member 1 | 10 |
| Member 2 | 30 |
| Member 3 | 0 |
| Member 4 | 5 |
| . . . | . . . |

The record score information storage unit 114 stores information on a record score corresponding to each of the plurality of members (the record score of each of the plurality of members means a score calculated according to the game record of each member).

TABLE 4

| | |
|---|---|
| Plurality | |
| of members | Record score |

| | | |
|---|---|---|
| Member 1 | 6 wins 3 losses | 55 points |
| Member 2 | 4 wins 5 losses | 38 points |
| Member 3 | 3 wins 11 losses | 28 points |
| Member 4 | 5 wins 7 losses | 46 points |
| . . . | . . . | . . . |

In such a situation, an operator of the service providing server 110 according to the present disclosure may hold a tournament competition for each of the plurality of games in order to provide the tournament game service, and in this case, the operator may open a tournament session of each of the plurality of games online in order to allow the members to participate in the tournament competition for each of the plurality of games online through client terminals held by the members.

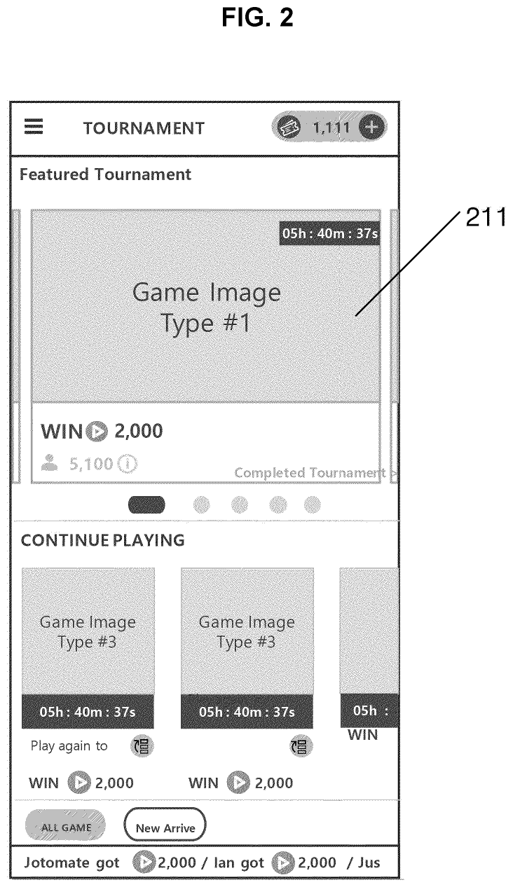

In this regard, FIG. 2 is a diagram illustrating an example of a screen in which when a specific member accesses the service providing server 110 through a client terminal thereof, a tournament session of each of the plurality of games is opened, which may be viewed through the client terminal. Here, when reference numeral 211 of FIG. 2 represents a screen in which a tournament session for a first game which is any one of the plurality of games is opened, the tournament session means a session opened so as for members who accesses the tournament session to play the first game online jointly through the client terminal. That is, multiple members access the tournament session through client terminals thereof to play the first game jointly with each other online.

As a result, when a first member which is any one of the plurality of members accesses the service providing server 110 through a first client terminal 150 thereof, the first member may view a waiting room screen having a UI shown in FIG. 2 through the first client terminal 150.

In this case, when the first member clicks on the tournament session for the first game represented by reference numeral 211 through the first client terminal 150, the first client terminal 150 may transmit, to the service providing server 110 of the present disclosure, an access request command to the tournament session.

In this case, when the confirmation unit 115 receives, from the first client terminal 150, the access request command to the tournament session opened for the first game, the confirmation unit 115 conducts certification for the first member, and then confirms a first required number which is the number of required tickets for participating in the tournament of the first game by referring to the ticket number information storage unit 111, and confirms the quantity of holding tickets held by the first member by referring to the ticket quantity information storage unit 113.

When it is confirmed that the quantity of holding tickets held by the first member is equal to or more than the first required number, the reduction processing unit 116 allows the first client terminal 150 to access the tournament session, and then reduces the quantity of holding tickets held by the first member stored in the ticket quantity information storage unit 113 by the first required number.

The update event generation unit 117 generates an update event for updating the record score of the first member when it is determined that the first member wins according to a result in which the first member matches a second member who accesses the tournament session, and performs the battle for the first game after the access of the first client terminal 150 to the tournament session is permitted.

Hereinafter, operations of the confirmation unit 115, the reduction processing unit 116, and the update event generation unit 117 will be described in detail as an example.

First, it is assumed that the first game is ‘game 2’, the first member is ‘member 1’, and a second member is ‘member 2’.

In this case, when the service providing server 110 receives, from the first client terminal 150, the access request command to the tournament session opened for ‘game 2’ which is the first game, the confirmation unit 115 may conduct certification for ‘ member 1’ which is the first member, and then confirm, as a first required number, ‘1’ which is the number of required tickets for participating in the tournament of ‘game 2 which is the first game by referring to the ticket number information storage unit 111 shown in Table 1 above, and confirm ‘10’ as the quantity of holding tickets held by ‘member 1’ which is the first member by referring to the ticket quantity information storage unit 113 shown in Table 3 above.

In this case, since ‘10’ which is the quantity of holding tickets held by ‘member 1’ which is the first member is equal to or more than ‘1’ which is the first required number, the reduction processing unit 116 reduces ‘10’ which is the quantity of holding tickets held by ‘member 1’ which is the first member stored in the ticket quantity information storage unit 113 shown in Table 3 by ‘1’ which is the first required number after permitting the access of the first client terminal 150 to the tournament session to update quantity information for ‘member 1’ as in Table 5 below.

TABLE 5

| Plurality | Quantity of |
|---|---|
| of members | holding tickets |
| Member 1 | 9 |
| Member 2 | 30 |
| Member 3 | 0 |
| Member 4 | 5 |
| . . . | . . . |

As described above, the update event generation unit 117 generates an update event for updating the record score of ‘member 1’ which is the first member when it is determined that ‘member 1’ which is the first member wins according to a result in which ‘member 1’ which is the first member matches ‘member 2’ which is the second member who accesses the tournament session, and performs the battle for ‘game 2’ which is the first game after the access of the first client terminal 150 to the tournament session is permitted.

The record score update unit 118 updates a first record score for the first member stored in the record score information storage unit 114 based on a first game score corresponding to the first game stored in the game score information storage unit 112 when the update event is generated.

In this case, according to an exemplary embodiment of the present disclosure, the record score update unit 118 may include a genre information storage unit 120, a preferred genre information storage unit 121, a reference record score information storage unit 122, a composite information confirmation unit 123, a genre correction value selection unit 124, a record correction value selection unit 125, a victory score calculation unit 126, and an update unit 127.

The genre information storage unit 120 stores information on a predetermined genre corresponding to each of the plurality of games (the genre of each of the plurality of games means any one genre pre-designated to correspond to each game among predetermined s (s is a natural number of 2 or more) types of genres).

For example, when it is assumed that s is ‘5’, and predetermined five types of genres are ‘RPG, adventure, shooting, racing, and sports’, the genre information storage unit 120 may store information shown in Table 6 below.

TABLE 6

| Plurality | |
|---|---|
| of games | Genres |
| Game 1 | RPG |
| Game 2 | Sports |
| Game 3 | Racing |
| Game 4 | Adventure |
| . . . | . . . |

The preferred genre information storage unit 121 stores information on pre-designated t (t is a natural number of 2 or more) preferred genres corresponding to each of the plurality of members (t preferred genres of each of the plurality of members mean t genres pre-designated as a genre preferred by each member among the s types of genres).

For example, when it is assumed that t is ‘2’, the preferred genre information storage unit 121 may store information shown in Table 7 below.

TABLE 7

| Plurality | Two preferred |
|---|---|
| of members | genres |
| Member 1 | Sports and racing |
| Member 2 | Sports and RPG |
| Member 3 | Racing and shooting |
| Member 4 | Adventure and RPG |
| . . . | . . . |

The reference record score information storage unit 122 stores information on a pre-designated reference record score corresponding to each of the plurality of games (the reference record score of each of the plurality of games is a score designated to be different from each other according to the difficulty of each game, and a high reference record score is pre-designated for a game having a high difficulty and a low reference record score is pre-designated for a game having a low difficulty).

For example, the reference record score information storage unit 122 may store information shown in Table 8 below.

TABLE 8

| Plurality | Reference |
|---|---|
| of games | record score |
| Game 1 | 40 points |
| Game 2 | 20 points |
| Game 3 | 30 points |
| Game 4 | 50 points |
| . . . | . . . |

When the update event is generated, the composite information confirmation unit 123 confirms the first game score corresponding to the first game by referring to the game score information storage unit 112, confirms a first genre corresponding to the first game by referring to the genre information storage unit 120, confirms t first preferred genres for the first member by referring to the preferred genre information storage unit 121, confirms a first reference record score corresponding to the first game by referring to the reference record score information storage unit 122, and confirms the first record score for the first member by referring to the record score information storage unit 114.

The genre correction value selection unit 124 determines whether the first genre belongs to one of the first preferred genres, and when determining that the first genre belongs to one of the first preferred genres, selects a predetermined first genre correction value (the first genre correction value is a rational number which is more than 0 and less than 1), and when determining that the first genre does not belong to one of the first preferred genres, selects a predetermined second genre correction value (the second genre correction value is a rational number which is more than 1 and less than 2).

The record correction value selection unit 125 determines whether the first record score is more than the first reference record score, and when determining that the first record score is more than the first reference record score, selecting a predetermined first record correction value (the first record correction value is a rational number which is more than 0 and less than 1), and when determining that the first record score is not more than the first reference record score, selecting a predetermined second record correction value (the second record correction value is a rational number which is more than 1 and less than 2).

The victory score calculation unit 126 calculates a victory score according to winning the first game of the first member according to Equation 1 below based on the first game score.

$$\\ \begin{matrix}VS = {GS}_{1} \times GCV + {GS}_{1} \times RCV & [ Equation 1 ]\end{matrix}$$

Where victory score (VS) represents the victory score, game score (GS)₁ represents the first game score, genre correction value (GCV) represents any one genre correction value selected by the genre correction value selection unit 124 between the first genre correction value or the second genre correction value, and record correction value (RCV) represents any one record correction value selected by the record correction value selection unit 125 between the first record correction value or the second record correction value.

When the victory score is calculated, the update unit 127 adds the victory score in the first record score stored in the record score information storage unit 114 to update the first record score.

Hereinafter, operations of the composite information confirmation unit 123, the genre correction value selection unit 124, the record correction value selection unit 125, the victory score calculation unit 126, and the update unit 127 will be described in detail as an example.

First, it is assumed that a predetermined first genre correction value is ‘0.5’, a predetermined second genre correction value is ‘1.5’, a predetermined first record correction value is ‘0.6’, and a predetermined second record correction value is ‘1.6’, and as in the above-described example, the update event is generated by the update event generation unit 117.

Then, the composite information confirmation unit 123 may confirm ‘8 points’ which is the first game score corresponding to ‘game 2’ which is the first game by referring to the game score information storage unit 112 shown in Table 2 above, confirm ‘sports’ which is the first genre corresponding to ‘game 2’ which is the first game by referring to the genre information storage unit 120 shown in Table 6 above, confirm ‘sports and racing’ which are two first preferred genres for ‘member 1’ which is the first member by referring to the preferred genre information storage unit 121 shown in Table 7 above, confirm ‘20 points’ which is the first reference record score corresponding to ‘game 2’ which is the first game by referring to the reference record score information storage unit 122 show in Table 8 above, and confirm ‘55 points’ which is the first record score for ‘member 1’ which is the first member by referring to the record score information storage unit 114 shown in Table 4 above.

Then, the genre correction value selection unit 124 may determine whether ‘sports’ which is the first genre belongs to one of ‘sports and racing’ which are the first preferred genres.

In this case, since ‘sports’ which is the first genre belongs to one of ‘sports and racing’ which are the first preferred genres, the genre correction value selection unit 124 may select ‘0.5’ which is the first genre correction value.

Thereafter, the record correction value selection unit 125 may determine whether ‘55 points’ which is the first record score is more than ‘20 points’ which is the first reference record score.

In this case, since ‘55 points’ which is the first record score is more than ‘20 points’ which is the first reference record score, the record correction value selection unit 125 may select ‘0.6’ which is the first record correction value.

Then, the victory score calculation unit 126 may calculate ‘8.8’ as a victory score according to winning ‘game 2’ which is the first game of ‘member 1’ which is the first member according to Equation 1 above based on ‘8 points’ which is the first game score, ‘0.5’ which is the first genre correction value, and ‘0.6’ which is the first record correction value.

As described above, when the victory score is calculated by the victory score calculation unit 126, the update unit 127 adds ‘8.8’ which is the victory score in ‘55 points’ which is the first record score stored in the record score information storage unit 114 shown in Table 4 above to update ‘55 points’ which is the first record score as in Table 9 below.

TABLE 9

| | |
|---|---|
| Plurality of members | Record score |

| | | | |
|---|---|---|---|
| Member 1 | 7 wins 3 losses | 63.8 | points |
| Member 2 | 4 wins 6 losses | 38 | points |
| Member 3 | 3 wins 11 losses | 28 | points |
| Member 4 | 5 wins 7 losses | 46 | points |

| | | |
|---|---|---|
| . . . | . . . | . . . |

When the first record score is updated, the record score transmission unit 119 transmits information on the updated first record score to the first client terminal 150.

For example, as in the above-described example, when the record score update unit 118 updates the first record score to ‘63.8’, the record score transmission unit 119 may transmit information on ‘63.8 points’ which is the updated first record score to the first client terminal 150.

Through this, ‘member 1’ which is the first member may confirm ‘63.8 points’ which is the updated first record score.

According to an exemplary embodiment of the present disclosure, the service providing server 110 may further include a component which conducts a process of upon receiving the access request command to the tournament session opened for the first game from the first client terminal 150 of the first member, performing the certification for the first member, and then only when it is confirmed that the first member is a certified member, determining whether to permit the first client terminal 150 to access the tournament session based on the ticket held by the first member.

To this end, the confirmation unit 115 may include an e-mail storage unit 128, a public key storage unit 129, a certification event generation unit 130, a certification information generation unit 131, a designation unit 132, an electronic signature request unit 133, a determination unit 134, and a certification completion processing unit 135.

The e-mail storage unit 128 stores information on a predetermined e-mail address for each of the plurality of members.

For example, the e-mail storage unit 128 may store information shown in Table 10 below.

TABLE 10

| Plurality of members | E-mail address |
|---|---|
| Member 1 | E-mail address 1 |
| Member 2 | E-mail address 2 |
| Member 3 | E-mail address 3 |
| Member 4 | E-mail address 4 |
| . . . | . . . |

The public key storage unit 129 stores a public key corresponding to a private key (the private key for each of the plurality of members is prestored in the client terminal of each member) pre-issued for each of the plurality of members.

For example, the public key storage unit 129 may store a public key corresponding to a private key pre-issued for each of the plurality of members as in Table 11 below.

TABLE 11

| | |
|---|---|
| Private key pre-issued for | |
| each of plurality of members | Public key |

| | | |
|---|---|---|
| Member 1 | Private key 1 | Public key 1 |
| Member 2 | Private key 2 | Public key 2 |
| Member 3 | Private key 3 | Public key 3 |
| Member 4 | Private key 4 | Public key 4 |
| . . . | . . . | . . . |

The certification event generation unit 130 generates a certification event for conducting the certification for the first member when receiving the access request command to the tournament session from the first client terminal 150.

The certification information generation unit 131 randomly generates, when the certification event is generated, a n (n is a natural number of 2 or more)-digit first certification number, randomly generates a certification value constituted by a natural number having a size of 9 or less, and then, performs a modulo operation having the certification value as a divisor for respective digit numbers constituting the first certification number to generate an n-digit second certification number.

The designation unit 132 generates a column vector having respective digit numbers constituting the first certification number as components and a row vector having respective digit numbers constituting the second certification number as components, and computes a matrix multiplication between the column vector and the row vector to generate an operation matrix of an n×n size, and then computes Frobenius Norm of the operation matrix, and designates the Frobenius Norm of the operation matrix as a verification value for member certification.

Here, when there is matrix A having a size of p×q, the Frobenius Norm of the matrix A may be computed according to Equation 2 below.

$$\\ \begin{matrix}{‖ A ‖}_{F} = \sqrt{{\sum }_{i = 1}^{p} {\sum }_{j = 1}^{q} {a}_{ij}^{{}_{} 2}} & [ Equation 2 ]\end{matrix}$$

In Equation 2 above, ∥A∥_{F} means the Frobenius Norm of the matrix A and αᵢⱼ means a component at a location of i-th row and j-th column among components of the matrix A.

The electronic signature request unit 133 confirms a first e-mail address for the first member by referring to the e-mail storage unit 128, sends a certification e-mail including the first certification number with the first e-mail address as a receiving side, and then transmits the certification value to the first client terminal 150, and at the same time, requests an electronic signature based on the first certification number and the certification value.

In this case, according to an exemplary embodiment of the present disclosure, the first client terminal 150 may pre-store a first private key pre-issued for the first member in the first client terminal 150, and upon receiving the electronic signature request from the service providing server 110 jointly with the certification value, the first client terminal 150 may display a message for requesting the first member to input the first certification number included in the certification e-mail received by an account according to the first e-mail address into the first client terminal 150.

In this case, when the first member inputs, into the first client terminal 150, the first certification number included in the certification e-mail received by the account according to the first e-mail address in response to the message, the first client terminal 150 performs the modulo operation having the certification value as the divisor for the respective digit numbers constituting the first certification number to generate the n-digit second certification number, and then generate a column vector having respective digit numbers constituting the first certification number as components and a row vector having respective digit numbers constituting the second certification number as components, and computes the matrix multiplication between the column vector and the row vector to generate the operation matrix of the n×n size, and then encrypts the Frobenius Norm of the operation matrix with the first private key stored in the first client terminal 150 to generate a first electronic signature value, and transmit the generated first electronic signature value to the service providing server 110.

When the determination unit 134 receives the first electronic signature from the first client terminal 150, the determination unit 134 decrypts the first electronic signature value with the first public key corresponding to the first private key stored in the public key storage unit 129 to generate a decryption value, and then determines whether the decryption value is equal to the Frobenius Norm of the operation matrix designated as the verification value.

The certification completion processing unit 135 completes certification for the first member when it is determined that the decryption value is equal to the Frobenius Norm of the operation matrix designated as the verification value.

Hereinafter, operations of the certification event generation unit 130, the certification information generation unit 131, the designation unit 132, the electronic signature request unit 133, the first client terminal 150, the determination unit 134, and the certification completion processing unit 135 will be described in detail as an example.

First, it is assumed that ‘n=3’, and as in the above-described example, the service providing server 110 receives the access request command to the tournament session from the first client terminal 150.

Then, the certification event generation unit 130 may generate a certification event for conducting the certification for ‘member 1’ which is the first member.

As described above, when the certification event is generated by the certification event generation unit 130, the certification information generation unit 131 may randomly generate a 3-digit first certification number as ‘642’, and randomly generate a certification value configured by a natural number having a size of 9 or less as ‘5’.

Thereafter, the certification information generation unit 131 performs a modulo operation having ‘5’ which is the certification value as the divisor for respective-digit numbers constituting ‘642’ which is the first certification number to generate a 3-digit second certification number, ‘142’.

Then, the designation unit 132 may generate

$$\\ ‘ [ \begin{matrix}6 \\ 4 \\ 2\end{matrix} ] ’$$

which is a 3D column vector having the respective-digit numbers constituting ‘642’ which is the first certification number as components, and ‘[142]’, which is a 3D row vector having respective-digit numbers constituting ‘142’ which is the second certification number as components.

Thereafter, the designation unit 132 computes a matrix multiplication between

$$\\ ‘ [ \begin{matrix}6 \\ 4 \\ 2\end{matrix} ] ’$$

which is the column vector and ‘[142]’ which is the row vector to generate an operation matrix having a size of 3×3 such as

$$\\ ‘ [ \begin{matrix}6 & 24 & 12 \\ 4 & 16 & 8 \\ 2 & 8 & 4\end{matrix} ] ’ .$$

As described above, when the operation matrix is generated by the designation unit 132, the designation unit 132 may compute the Frobenius Norm of

$$\\ ‘ [ \begin{matrix}6 & 24 & 12 \\ 4 & 16 & 8 \\ 2 & 8 & 4\end{matrix} ] ’$$

which is the operation matrix as ‘34.29’ according to Equation 2 above, and designate ‘34.29’ which is the Frobenius Norm as a verification value for member certification.

Then, the electronic signature request unit 133 may confirm ‘e-mail address 1’ which is the first e-mail address for ‘member 1’ which is the first member by referring to the e-mail storage unit 128 shown in Table 10 above, send a certification e-mail including ‘642’ which is the first certification number with ‘e-mail address 1’ which is the first e-mail address as a receiving side, and then transmit ‘5’ which is the certification value to the first client terminal 150, and at the same time, request an electronic signature based on ‘642’ which is the first certification number and ‘5’ which is the certification value.

In this case, the first client terminal 150 may pre-store ‘private 1’ which is the first private key pre-issued for ‘member 1’ which is the first member in the first client terminal 150, and when the first client terminal 150 receives the electronic signature request from the service providing server 110 jointly with ‘5’ which is the certification value, the first client terminal 150 may display a message which requests ‘member 1’ which is the first member to input the first certification number included in the certification e-mail received into the account according to ‘e-mail address 1’ which is the first e-mail address into the first client terminal 150.

Then, ‘member 1’ which is the first member logs into the account according to ‘e-mail address 1’ which is the first e-mail address to confirm the certification e-mail, and confirms ‘642’ which is the first certification number included in the certification e-mail to input ‘642’ into the first client terminal 150.

As such, when ‘member 1’ which is the first member inputs ‘642’ which is the first certification number included in the certification e-mail into the first client terminal 150, the first client terminal 150 performs a modulo operation having ‘5’ which is the certification value as the divisor for respective digit numbers constituting ‘642’ which is the first certification number to generate a 3-digit second certification number as ‘142’.

Then, the first client terminal 150 may generate

$$\\ ‘ [ \begin{matrix}6 \\ 4 \\ 2\end{matrix} ] ’$$

which is the column vector having the respective-digit numbers constituting ‘642’ which is the first certification number as components, and ‘[142]’ which is the row vector having respective-digit numbers constituting ‘142’ which is the second certification number as components.

Thereafter, the first client terminal 150 computes a matrix multiplication between

$$\\ ‘ [ \begin{matrix}6 \\ 4 \\ 2\end{matrix} ] ’$$

which is the column vector and ‘[142]’ which is the row vector to generate an operation matrix having a size of 3×3 such as

$$\\ ‘ [ \begin{matrix}6 & 24 & 12 \\ 4 & 16 & 8 \\ 2 & 8 & 4\end{matrix} ] ’ .$$

Then, the first client terminal 150 may compute the Frobenius Norm of

$$\\ [ \begin{matrix}6 & 24 & 12 \\ 4 & 16 & 8 \\ 2 & 8 & 4\end{matrix} ]$$

which is the operation matrix as ‘34.29’ according to Equation 2 above, and encrypt ‘34.29’ which is the Frobenius Norm with ‘private key 1’ which is the first private key stored in the first client terminal 150 to generate a first electronic signature value, and then transmit the first electronic signature value to the service providing server 110.

In this case, when the service providing server 110 receives the first electronic signature from the first client terminal 150, the determination unit 134 decrypts the first electronic signature value with ‘public key 1’ which is the first public key corresponding to ‘private key 1’ which is the first private key stored in the public key storage unit 129 shown in Table 11 above to generate a decryption value such as ‘34.29’, and then determine whether ‘34.29’ which is the decryption value is equal to ‘34.29’ which is the Frobenius Norm designated as the verification value.

In this case, since ‘34.29’ which is the decryption value is equal to ‘34.29’ which is the Frobenius Norm designated as the verification value, the certification completion processing unit 135 may complete the certification for ‘member 1’ which is the first member.

According to an exemplary embodiment of the present disclosure, the service providing server 110 may further include a reward information storage unit 136, a wallet address information request unit 137, a payment amount confirmation unit 138, and a reward processing unit 139.

The reward information storage unit 136 stores information on a payment amount of cryptocurrency corresponding to each of a plurality of different pre-designated reward reference scores (the payment amount of cryptocurrency corresponding to each of the plurality of reward reference scores means a reward money pre-designated to be paid as a reward when the record score of the member reaches each reward reference score).

For example, the reward information storage unit 136 may store information as in Table 12 below.

TABLE 12

| Plurality of | Payment amount of | |
|---|---|---|
| reward reference scores | cryptocurrency | |
| 20 points | 1 | coins |
| 40 points | 3 | coins |
| 60 points | 6 | coins |
| 70 points | 10 | coins |
| 80 points | 14 | coins |

| | |
|---|---|
| . . . | . . . |

When it is confirmed that the first record score of the first member stored in the record score information storage unit 114 reaches a first reward reference score which is any one of the plurality of reward reference scores, the wallet address information request unit 137 requests the first client terminal 150 to transmit wallet address information for accumulating cryptocurrency.

When the payment amount confirmation unit 138 receives first wallet address information from the first client terminal 150, the payment amount confirmation unit 138 confirms a first payment amount corresponding to the first reward reference score by referring to the reward information storage unit 136.

When the first payment amount is confirmed, the reward processing unit 139 transfers cryptocurrency corresponding to the first payment amount based on the first wallet address information to complete reward processing for the first member.

Hereinafter, operations of the wallet address information request unit 137, the payment amount confirmation unit 138, and the reward processing unit 139 will be described in detail as an example.

First, as in the above-described example, it is assumed that the first record score is updated to ‘68.3 points’ by the record score update unit 118.

In this case, since ‘68.3 points’ which is the first record score of ‘member 1’ which is the first member stored in the record score information storage unit 114 shown in Table 9 reaches ‘60 points’ which is any one first reward reference score among ‘20 points, 40 points, 60 points, 70 points, 80 points, . . . ’ which are the plurality of reward reference scores, the wallet address information request unit 137 may request the first client terminal 150 to transmit the wallet address information for accumulating the cryptocurrency.

In response thereto, when the service providing server 110 receives ‘wallet address information 1’ from the first client terminal 150, the payment amount confirmation unit 138 may confirm ‘6 coins’ which is a first payment amount corresponding to ‘60 points’ which is the first reward reference score by referring to the reward information storage unit 136 shown in Table 12 above.

As described above, when the first payment amount is confirmed by the payment amount confirmation unit 138, the reward processing unit 139 transfers cryptocurrency corresponding to ‘6 coins’ corresponding to the first payment amount based on ‘wallet address information 1’ to complete the reward processing for ‘member 1’ which is the first member.

According to an exemplary embodiment of the present disclosure, the service providing server 110 may further include a price information storage unit 140, a payment means information request unit 141, a payment processing unit 142, and an increment processing unit 143.

The price information storage unit 140 stores purchase price information of the ticket for participating in the tournament.

For example, the price information storage unit 140 may store purchase price information of ‘5000 won per ticket’ as the purchase price information of the ticket.

When the payment means information request unit 141 receives a purchase request command for requesting purchasing tickets corresponding to a first purchase quantity from the first client terminal 150, the payment means information request unit 141 requests transmitting payment means information for cost payment.

When the payment processing unit 142 receives first payment means information from the first client terminal 150, the payment processing unit 142 calculates a price corresponding to the first purchase quantity based on the purchase price information, and then performs cost payment processing for the calculated price based on the first payment means information.

When the cost payment processing is completed, the increment processing unit 143 increases the quantity of holding tickets held by the first member stored in the ticket quantity information storage unit 113 by the first purchase quantity.

Hereinafter, operations of the payment means information request unit 141, the payment processing unit 142, and the increment processing unit 143 will be described in detail as an example.

First, as in the above-described example, it is assumed that after ‘10 which is the quantity of holding tickets held by ‘member 1’ which is the first member is reduced by ‘1’ which is the first required number by the reduction processing unit 116, and then the service providing server 110 receives the purchase request command for requesting purchasing tickets corresponding to the first purchase quantity such as ‘5’ from the first client terminal 150.

Then, the payment means information request unit 141 may request transmitting the payment means information for cost payment.

In response thereto, when the service providing server 110 receives ‘credit card information’ from the first client terminal 150, the payment processing unit 142 may calculate, as 25000 won′, a price corresponding to ‘5’ which is the first purchase quantity based on the purchase price information.

Thereafter, the payment processing unit 142 may perform cost payment processing for ‘25000 won’ which is the calculated price based on the ‘credit card information’.

As described above, when the cost payment processing is completed by the payment processing unit 142, the increment processing unit 143 increases ‘9 which is the quantity of holding tickets held by ‘member 1’ which is the first member stored in the ticket quantity information storage unit 113 shown in Table 5 by ‘5’ which is the first purchase quantity to update quantity information for ‘member 1’ as in Table 13 below.

TABLE 13

| Plurality | Quantity of |
|---|---|
| of members | holding tickets |
| Member 1 | 14 |
| Member 2 | 30 |
| Member 3 | 0 |
| Member 4 | 5 |
| . . . | . . . |

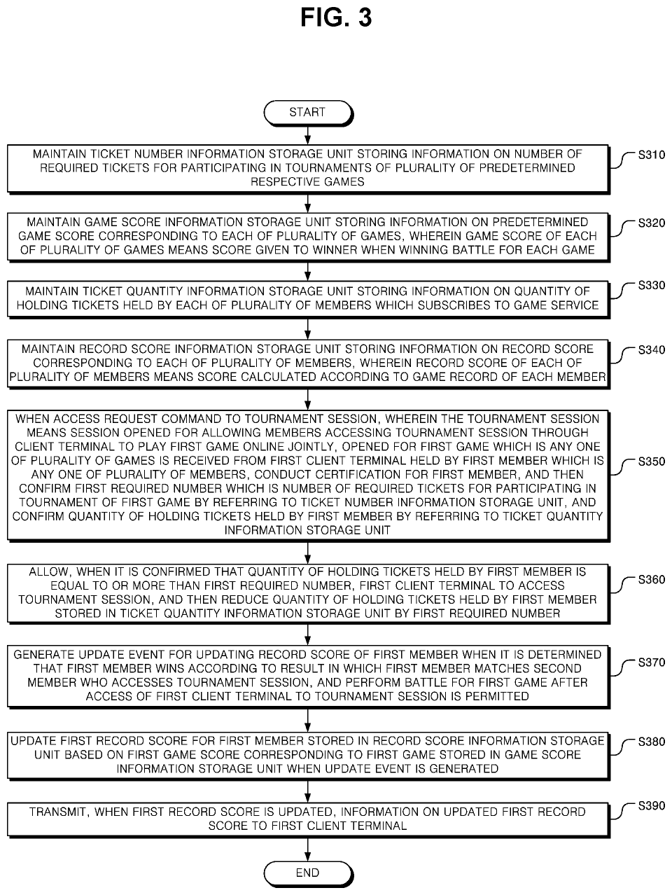

FIG. 3 is a flowchart illustrating an operating method of a service providing server for providing the game service that supports participation in a tournament for a game using a ticket and that gives the customized score according to the record about the member who participated in the tournament according to an exemplary embodiment of the present disclosure.

In step S310, a ticket number information storage unit is maintained, which stores information on the number of required tickets for participating in tournaments of a plurality of predetermined respective games.

In step S320, a game score information storage unit is maintained, which stores information on a predetermined game score corresponding to each of the plurality of games (the game score of each of the plurality of games means a score given to a winner when winning a battle for each game).

In step S330, a ticket quantity information storage unit is maintained, which stores information on the quantity of holding tickets held by each of a plurality of members which subscribes to the game service.

In step S340, a record score information storage unit 114 is maintained which stores information on a record score corresponding to each of the plurality of members (the record score of each of the plurality of members means a score calculated according to the game record of each member).

In step S350, when an access request command to a tournament session (the tournament session means a session opened for allowing members accessing the tournament session through the client terminal to play the first game online jointly) opened for a first game which is any one of the plurality of games is received from a first client terminal held by a first member which is any one of the plurality of members, certification for the first member is conducted, and then a first required number which is the number of required tickets for participating in the tournament of the first game is confirmed by referring to the ticket number information storage unit, and the quantity of holding tickets held by the first member is confirmed by referring to the ticket quantity information storage unit.

In step S360, when it is confirmed that the quantity of holding tickets held by the first member is equal to or more than the first required number, the first client terminal is allowed to access the tournament session, and then the quantity of holding tickets held by the first member stored in the ticket quantity information storage unit is reduced by the first required number.

In step S370, an update event for updating the record score of the first member is generated when it is determined that the first member wins according to a result in which the first member matches a second member who accesses the tournament session, and performs the battle for the first game after the access of the first client terminal to the tournament session is permitted.

In step S380, a first record score for the first member stored in the record score information storage unit is updated based on a first game score corresponding to the first game stored in the game score information storage unit when the update event is generated.

In step S390, when the first record score is updated, information on the updated first record score is transmitted to the first client terminal.

In this case, according to an exemplary embodiment of the present disclosure, step S380 may include a step of maintaining a genre information storage unit storing information on a predetermined genre corresponding to each of the plurality of games, wherein the genre of each of the plurality of games means any one genre pre-designated to correspond to each game among predetermined s (s is a natural number of 2 or more) types of genres, a step of maintaining a preferred genre information storage unit storing information on pre-designated t (t is a natural number of 2 or more) preferred genres corresponding to each of the plurality of members, wherein t preferred genres of each of the plurality of members mean t genres pre-designated as a genre preferred by each member among the s types of genres, a step of maintaining a reference record score information storage unit storing information on a pre-designated reference record score corresponding to each of the plurality of games, wherein the reference record score of each of the plurality of games is a score designated to be different from each other according to the difficulty of each game, and a high reference record score is pre-designated for a game having a high difficulty and a low reference record score is pre-designated for a game having a low difficulty, a step of confirming, when the update event is generated, the first game score corresponding to the first game by referring to the game score information storage unit, confirming a first genre corresponding to the first game by referring to the genre information storage unit, confirming t first preferred genres for the first member by referring to the preferred genre information storage unit, confirming a first reference record score corresponding to the first game by referring to the reference record score information storage unit, and confirming the first record score for the first member by referring to the record score information storage unit, a step of determining whether the first genre belongs to one of the first preferred genres, and when determining that the first genre belongs to one of the first preferred genres, selecting a predetermined first genre correction value, wherein the first genre correction value is a rational number which is more than 0 and less than 1, and when determining that the first genre does not belong to one of the first preferred genres, selecting a predetermined second genre correction value, wherein the second genre correction value is a rational number which is more than 1 and less than 2, a step of determining whether the first record score is more than the first reference record score, and when determining that the first record score is more than the first reference record score, selecting a predetermined first record correction value, wherein the first record correction value is a rational number which is more than 0 and less than 1, and when determining that the first record score is not more than the first reference record score, selecting a predetermined second record correction value, wherein the second record correction value is a rational number which is more than 1 and less than 2, a step of calculating a winning score according to winning the first game of the first member according to Equation 1 below based on the first game score, and adding, when the victory score is calculated, the victory score in the first record score stored in the record score information storage unit to update the first record score.

In this case, according to an exemplary embodiment of the present disclosure, step S350 may include a step of maintaining an e-mail storage unit storing information on a predetermined e-mail address for each of the plurality of members, a step of maintaining a public key storage unit storing a public key corresponding to a private key, wherein the private key for each of the plurality of members is pre-stored in the client terminal of each member, pre-issued for each of the plurality of members, a step of generating a certification event for conducting the certification for the first member when receiving the access request command to the tournament session from the first client terminal, randomly generating, when the certification event is generated, a n (n is a natural number of 2 or more)-digit first certification number, randomly generating a certification value constituted by a natural number having a size of 9 or less, and then, performing a modulo operation having the certification value as a divisor for respective digit numbers constituting the first certification number to generate an n-digit second certification number, generating a column vector having respective digit numbers constituting the first certification number as components and a row vector having respective digit numbers constituting the second certification number as components, and computing a matrix multiplication between the column vector and the row vector to generate an operation matrix of an n×n size, and then operating Frobenius Norm of the operation matrix, and designating the Frobenius Norm of the operation matrix as a verification value for member certification, confirming a first e-mail address for the first member by referring to the e-mail storage unit, sending a certification e-mail including the first certification number with the first e-mail address as a receiving side, and then transmitting the certification value to the first client terminal, and at the same time, requesting an electronic signature based on the first certification number and the certification value, when receiving a first electronic signature value, wherein the first electronic signature value is generated by performing, when the certification value is received in the first client terminal, and the first member inputs the first certification number included in the certification e-mail received by an account according to the first e-mail address into the first client terminal, by the first client terminal, the modulo operation having the certification value as the divisor for the respective digit numbers constituting the first certification number to generate the n-digit second certification number, and then generate a column vector having respective digit numbers constituting the first certification number as components and a row vector having respective digit numbers constituting the second certification number as components, and computing the matrix multiplication between the column vector and the row vector to generate the operation matrix of the n×n size, and then encrypting the Frobenius Norm of the operation matrix with the first private key pre-issued for the first member stored in the first client terminal, from the first client terminal in response to the electronic signature request, decrypting the first electronic signature value with a first public key corresponding to the first private key stored in the public key storage unit to generate a decryption value, and then determining whether the decryption value is equal to the Frobenius Norm of the operation matrix designated as the verification value, and completing certification for the first member when it is determined that the decryption value is equal to the Frobenius Norm of the operation matrix designated as the verification value.

Further, according to an exemplary embodiment of the present disclosure, the operating method of the service providing server may further include: a step of maintaining a compensation information storage unit storing information on a payment amount of cryptocurrency corresponding to each of a plurality of different pre-designated reward reference scores, wherein the payment amount of cryptocurrency corresponding to each of the plurality of reward reference scores means a reward money pre-designated to be paid as a reward when the record score of the member reaches each reward reference score; a step of requesting, when it is confirmed that the first record score of the first member stored in the record score information storage unit reaches a first reward reference score which is any one of the plurality of reward reference scores, the first client terminal to transmit wallet address information for accumulating cryptocurrency; a step of confirming a first payment amount corresponding to the first reward reference score by referring to the reward information storage unit when first wallet address information is received from the first client terminal; and a step of transferring, when the first payment amount is confirmed, cryptocurrency corresponding to the first payment amount based on the first wallet address information to complete reward processing for the first member.

Further, according to an exemplary embodiment of the present disclosure, the operating method of the service providing server may further include a step of maintaining a price information storage unit storing purchase price information of the ticket for participating in the tournament; a step of requesting, when a purchase request command for requesting purchasing tickets corresponding to a first purchase quantity is received from the first client terminal, transmitting payment means information for cost payment; a step of calculating, when first payment means information is received from the first client terminal, a price corresponding to the first purchase quantity based on the purchase price information, and then performing cost payment processing for the calculated price based on the first payment means information; and a step of increasing, when the payment processing is completed, the quantity of holding tickets held by the first member stored in the ticket quantity information storage unit by the first purchase quantity.

Hereinabove, referring to FIG. 3, the operating method of the service providing server according to an exemplary embodiment of the present disclosure is described. Here, since the operating method of the service providing server according to an exemplary embodiment of the present disclosure may correspond to the configuration of the operation of the service providing server 110 described by using FIGS. 1 to 2, a more detailed description thereof will be omitted.

An operating method of a service providing server for providing the game service that supports participation in a tournament for a game using a ticket and that gives the customized score according to the record about the member who participated in the tournament according to the record about the member who participated in the tournament according to an exemplary embodiment of the present disclosure may be implemented by a computer program stored in a storage medium to be executed through a combination with a computer.

Further, an operating method of a service providing server for providing the game service that supports participation in a tournament for a game using a ticket and that gives the customized score according to the record about the member who participated in the tournament according to the record about the member who participated in the tournament according to an exemplary embodiment of the present disclosure may be implemented as a program command form which may be performed by various computer means, and recorded in a computer-readable medium. The computer readable medium may include a program command, a data file, a data structure, etc., singly or combinationally. The program command recorded in the medium may be specially designed and configured for the present disclosure, or may be publicly known to and used by those skilled in the computer software field. An example of the computer readable recording medium includes magnetic media, such as a hard disk, a floppy disk, and a magnetic tape, optical media such as a CD-ROM and a DVD, magneto-optical media such as a floptical disk, and hardware devices such as a ROM, a RAM, and a flash memory, which are specially configured to store and execute the program command. An example of the program command includes a high-level language code executable by a computer by using an interpreter and the like, as well as a machine language code created by a compiler.

As described above, the present disclosure has been described by specified matters such as detailed components, and the like and limited exemplary embodiments and drawings, but the description is just provided to assist more overall understanding of the present disclosure and the present disclosure is not limited to the exemplary embodiment and various modifications and changes can be made by those skilled in the art from such a disclosure.

Accordingly, the spirit of the present disclosure should not be defined only by the described exemplary embodiments, and it should be appreciated that claims to be described below and all things which are equivalent to the claims or equivalently modified to the claims are included in the scope of the spirit of the present disclosure.

What is claimed is:

1. A service providing server for providing the game service that supports participation in a tournament for a game using a ticket and that gives the customized score according to the record about the member who participated in the tournament, comprising:
a ticket number information storage unit storing information on the number of required tickets for participating in tournaments of a plurality of predetermined respective games;
a game score information storage unit storing information on a predetermined game score corresponding to each of the plurality of games, wherein the game score of each of the plurality of games means a score given to a winner when winning a battle for each game;
a ticket quantity information storage unit storing information on the quantity of holding tickets held by each of a plurality of members which subscribes to the game service;
a record score information storage unit storing information on a record score corresponding to each of the plurality of members, wherein the record score of each of the plurality of members means a score calculated according to the game record of each member;
when an access request command to a tournament session, wherein the tournament session means a session opened for allowing members accessing the tournament session through the client terminal to play the first game online jointly, opened for a first game which is any one of the plurality of games is received from a first client terminal held by a first member which is any one of the plurality of members, a confirmation unit conducting certification for the first member, and then confirming a first required number which is the number of required tickets for participating in the tournament of the first game by referring to the ticket number information storage unit, and confirming the quantity of holding tickets held by the first member by referring to the ticket quantity information storage unit;
a reduction processing unit allowing, when it is confirmed that the quantity of holding tickets held by the first member is equal to or more than the first required number, the first client terminal to access the tournament session, and then reducing the quantity of holding tickets held by the first member stored in the ticket quantity information storage unit by the first required number;
an update event generation unit generating an update event for updating the record score of the first member when it is determined that the first member wins according to a result in which the first member matches a second member who accesses the tournament session, and performs the battle for the first game after the access of the first client terminal to the tournament session is permitted;
a record score update unit updating a first record score for the first member stored in the record score information storage unit based on a first game score corresponding to the first game stored in the game score information storage unit when the update event is generated; and
a record score transmission unit transmitting, when the first record score is updated, information on the updated first record score to the first client terminal.

2. The service providing server of claim 1, wherein the record score update unit includes
a genre information storage unit storing information on a predetermined genre corresponding to each of the plurality of games, wherein the genre of each of the plurality of games means any one genre pre-designated to correspond to each game among predetermined s, wherein s is a natural number of 2 or more, types of genres,
a preferred genre information storage unit storing information on pre-designated t, wherein t is a natural number of 2 or more, preferred genres corresponding to each of the plurality of members, wherein t preferred genres of each of the plurality of members mean t genres pre-designated as a genre preferred by each member among the s types of genres,
a reference record score information storage unit storing information on a pre-designated reference record score corresponding to each of the plurality of games, wherein the reference record score of each of the plurality of games is a score designated to be different from each other according to the difficulty of each game, and a high reference record score is pre-designated for a game having a high difficulty and a low reference record score is pre-designated for a game having a low difficulty,
a composite information confirmation unit confirming, when the update event is generated, the first game score corresponding to the first game by referring to the game score information storage unit, confirming a first genre corresponding to the first game by referring to the genre information storage unit, confirming t first preferred genres for the first member by referring to the preferred genre information storage unit, confirming a first reference record score corresponding to the first game by referring to the reference record score information storage unit, and confirming the first record score for the first member by referring to the record score information storage unit,
a genre correction value selection unit determining whether the first genre belongs to one of the first preferred genres, and when determining that the first genre belongs to one of the first preferred genres, selecting a predetermined first genre correction value, wherein the first genre correction value is a rational number which is more than 0 and less than 1, and when determining that the first genre does not belong to one of the first preferred genres, selecting a predetermined second genre correction value, wherein the second genre correction value is a rational number which is more than 1 and less than 2,
a record correction value selection unit determining whether the first record score is more than the first reference record score, and when determining that the first record score is more than the first reference record score, selecting a predetermined first record correction value, wherein the first record correction value is a rational number which is more than 0 and less than 1, and when determining that the first record score is not more than the first reference record score, selecting a predetermined second record correction value, wherein the second record correction value is a rational number which is more than 1 and less than 2,
a victory score calculation unit calculating a winning score according to winning the first game of the first member according to Equation 1 below based on the first game score, and
an update unit adding, when the victory score is calculated, the victory score in the first record score stored in the record score information storage unit to update the first record score,
$$\\ \begin{matrix}VS = {GS}_{1} \times GCV + {GS}_{1} \times RCV & [ Equation 1 ]\end{matrix}$$
wherein VS represents the victory score, GS₁ represents the first game score, GCV represents any one genre correction value selected by the genre correction value selection unit between the first genre correction value or the second genre correction value, and RCV represents any one record correction value selected by the record correction value selection unit between the first record correction value or the second record correction value.

3. The service providing server of claim 1, wherein the confirmation unit includes
an e-mail storage unit storing information on a predetermined e-mail address for each of the plurality of members,
a public key storage unit storing a public key corresponding to a private key, wherein the private key for each of the plurality of members is pre-stored in the client terminal of each member, pre-issued for each of the plurality of members,
a certification event generation unit generating a certification event for conducting the certification for the first member when receiving the access request command to the tournament session from the first client terminal,
a certification information generation unit randomly generating, when the certification event is generated, a n, wherein n is a natural number of 2 or more, digit first certification number, randomly generating a certification value constituted by a natural number having a size of 9 or less, and then, performing a modulo operation having the certification value as a divisor for respective digit numbers constituting the first certification number to generate an n-digit second certification number,
a designation unit generating a column vector having respective digit numbers constituting the first certification number as components and a row vector having respective digit numbers constituting the second certification number as components, and computing a matrix multiplication between the column vector and the row vector to generate an operation matrix of an n×n size, and then computing Frobenius Norm of the operation matrix, and designating the Frobenius Norm of the operation matrix as a verification value for member certification,
an electronic signature request unit confirming a first e-mail address for the first member by referring to the e-mail storage unit, sending a certification e-mail including the first certification number with the first e-mail address as a receiving side, and then transmitting the certification value to the first client terminal, and at the same time, requesting an electronic signature based on the first certification number and the certification value,
a determination unit, when receiving a first electronic signature value, wherein the first electronic signature value is generated by performing, when the certification value is received in the first client terminal, and the first member inputs the first certification number included in the certification e-mail received by an account according to the first e-mail address into the first client terminal, by the first client terminal, the modulo operation having the certification value as the divisor for the respective digit numbers constituting the first certification number to generate the n-digit second certification number, and then generate a column vector having respective digit numbers constituting the first certification number as components and a row vector having respective digit numbers constituting the second certification number as components, and computing the matrix multiplication between the column vector and the row vector to generate the operation matrix of the n×n size, and then encrypting the Frobenius Norm of the operation matrix with the first private key pre-issued for the first member stored in the first client terminal, from the first client terminal in response to the electronic signature request, decrypting the first electronic signature value with a first public key corresponding to the first private key stored in the public key storage unit to generate a decryption value, and then determining whether the decryption value is equal to the Frobenius Norm of the operation matrix designated as the verification value, and
a certification completion processing unit completing certification for the first member when it is determined that the decryption value is equal to the Frobenius Norm of the operation matrix designated as the verification value.

4. The service providing server of claim 1, further comprising:
a reward information storage unit storing information on a payment amount of cryptocurrency corresponding to each of a plurality of different pre-designated reward reference scores, wherein the payment amount of cryptocurrency corresponding to each of the plurality of reward reference scores means a reward money pre-designated to be paid as a reward when the record score of the member reaches each reward reference score,
a wallet address information request unit requesting, when it is confirmed that the first record score of the first member stored in the record score information storage unit reaches a first reward reference score which is any one of the plurality of reward reference scores, the first client terminal to transmit wallet address information for accumulating cryptocurrency,
a payment amount confirmation unit confirming a first payment amount corresponding to the first reward reference score by referring to the reward information storage unit when first wallet address information is received from the first client terminal, and
a reward processing unit transferring, when the first payment amount is confirmed, cryptocurrency corresponding to the first payment amount based on the first wallet address information to complete reward processing for the first member.

5. The service providing server of claim 1, further comprising:
a price information storage unit storing purchase price information of the ticket for participating in the tournament;
a payment means information request unit requesting, when a purchase request command for requesting purchasing tickets corresponding to a first purchase quantity is received from the first client terminal, transmitting payment means information for cost payment;
a payment processing unit calculating, when first payment means information is received from the first client terminal, a price corresponding to the first purchase quantity based on the purchase price information, and then performing cost payment processing for the calculated price based on the first payment means information; and
an increment processing unit increasing, when the payment processing is completed, the quantity of holding tickets held by the first member stored in the ticket quantity information storage unit by the first purchase quantity.

6. An operating method of a service providing server for providing the game service that supports participation in a tournament for a game using a ticket and that gives the customized score according to the record about the member who participated in the tournament, comprising:
maintaining a ticket number information storage unit storing information on the number of required tickets for participating in tournaments of a plurality of predetermined respective games;
maintaining a game score information storage unit storing information on a predetermined game score corresponding to each of the plurality of games, wherein the game score of each of the plurality of games means a score given to a winner when winning a battle for each game;
maintaining a ticket quantity information storage unit storing information on the quantity of holding tickets held by each of a plurality of members which subscribes to the game service;
maintaining a record score information storage unit storing information on a record score corresponding to each of the plurality of members, wherein the record score of each of the plurality of members means a score calculated according to the game record of each member;
when an access request command to a tournament session, wherein the tournament session means a session opened for allowing members accessing the tournament session through the client terminal to play the first game online jointly, opened for a first game which is any one of the plurality of games is received from a first client terminal held by a first member which is any one of the plurality of members, conducting certification for the first member, and then confirming a first required number which is the number of required tickets for participating in the tournament of the first game by referring to the ticket number information storage unit, and confirming the quantity of holding tickets held by the first member by referring to the ticket quantity information storage unit;
allowing, when it is confirmed that the quantity of holding tickets held by the first member is equal to or more than the first required number, the first client terminal to access the tournament session, and then reducing the quantity of holding tickets held by the first member stored in the ticket quantity information storage unit by the first required number;
generating an update event for updating the record score when it is determined that the first member wins according to a result in which the first member matches a second member who accesses the tournament session, and performs the battle for the first game after the access of the first client terminal to the tournament session is permitted;
updating a first record score for the first member stored in the record score information storage unit based on a first game score corresponding to the first game stored in the game score information storage unit when the update event is generated; and
transmitting, when the first record score is updated, information on the updated first record score to the first client terminal.

7. The operating method of claim 6, wherein the updating includes
maintaining a genre information storage unit storing information on a predetermined genre corresponding to each of the plurality of games, wherein the genre of each of the plurality of games means any one genre pre-designated to correspond to each game among predetermined s, wherein s is a natural number of 2 or more, types of genres,
maintaining a preferred genre information storage unit storing information on pre-designated t, wherein t is a natural number of 2 or more, preferred genres corresponding to each of the plurality of members, wherein t preferred genres of each of the plurality of members mean t genres pre-designated as a genre preferred by each member among the s types of genres,
maintaining a reference record score information storage unit storing information on a pre-designated reference record score corresponding to each of the plurality of games, wherein the reference record score of each of the plurality of games is a score designated to be different from each other according to the difficulty of each game, and a high reference record score is pre-designated for a game having a high difficulty and a low reference record score is pre-designated for a game having a low difficulty,
confirming, when the update event is generated, the first game score corresponding to the first game by referring to the game score information storage unit, confirming a first genre corresponding to the first game by referring to the genre information storage unit, confirming t first preferred genres for the first member by referring to the preferred genre information storage unit, confirming a first reference record score corresponding to the first game by referring to the reference record score information storage unit, and confirming the first record score for the first member by referring to the record score information storage unit,
determining whether the first genre belongs to one of the first preferred genres, and when determining that the first genre belongs to one of the first preferred genres, selecting a predetermined first genre correction value, wherein the first genre correction value is a rational number which is more than 0 and less than 1, and when determining that the first genre does not belong to one of the first preferred genres, selecting a predetermined second genre correction value, wherein the second genre correction value is a rational number which is more than 1 and less than 2,
determining whether the first record score is more than the first reference record score, and when determining that the first record score is more than the first reference record score, selecting a predetermined first record correction value, wherein the first record correction value is a rational number which is more than 0 and less than 1, and when determining that the first record score is not more than the first reference record score, selecting a predetermined second record correction value, wherein the second record correction value is a rational number which is more than 1 and less than 2,
calculating a winning score according to winning the first game of the first member according to Equation 1 below based on the first game score, and
adding, when the victory score is calculated, the victory score in the first record score stored in the record score information storage unit to update the first record score,
$$\\ \begin{matrix}VS = {GS}_{1} \times GCV + {GS}_{1} \times RCV & [ Equation 1 ]\end{matrix}$$
wherein VS represents the victory score, GS₁ represents the first game score, GCV represents any one genre correction value selected between the first genre correction value or the second genre correction value, and RCV represents any one record correction value selected between the first record correction value or the second record correction value.

8. The operating method of claim 6, wherein the conducting certification includes
maintaining an e-mail storage unit storing information on a predetermined e-mail address for each of the plurality of members,
maintaining a public key storage unit storing a public key corresponding to a private key, wherein the private key for each of the plurality of members is pre-stored in the client terminal of each member, pre-issued for each of the plurality of members,
generating a certification event for conducting the certification for the first member when receiving the access request command to the tournament session from the first client terminal,
randomly generating, when the certification event is generated, a n, wherein n is a natural number of 2 or more, digit first certification number, randomly generating a certification value constituted by a natural number having a size of 9 or less, and then, performing a modulo operation having the certification value as a divisor for respective digit numbers constituting the first certification number to generate an n-digit second certification number,
generating a column vector having respective digit numbers constituting the first certification number as components and a row vector having respective digit numbers constituting the second certification number as components, and computing a matrix multiplication between the column vector and the row vector to generate an operation matrix of an n×n size, and then operating Frobenius Norm of the operation matrix, and designating the Frobenius Norm of the operation matrix as a verification value for member certification,
confirming a first e-mail address for the first member by referring to the e-mail storage unit, sending a certification e-mail including the first certification number with the first e-mail address as a receiving side, and then transmitting the certification value to the first client terminal, and at the same time, requesting an electronic signature based on the first certification number and the certification value,
when receiving a first electronic signature value, wherein the first electronic signature value is generated by performing, when the certification value is received in the first client terminal, and the first member inputs the first certification number included in the certification e-mail received by an account according to the first e-mail address into the first client terminal, by the first client terminal, the modulo operation having the certification value as the divisor for the respective digit numbers constituting the first certification number to generate the n-digit second certification number, and then generate a column vector having respective digit numbers constituting the first certification number as components and a row vector having respective digit numbers constituting the second certification number as components, and computing the matrix multiplication between the column vector and the row vector to generate the operation matrix of the n×n size, and then encrypting the Frobenius Norm of the operation matrix with the first private key pre-issued for the first member stored in the first client terminal, from the first client terminal in response to the electronic signature request, decrypting the first electronic signature value with a first public key corresponding to the first private key stored in the public key storage unit to generate a decryption value, and then determining whether the decryption value is equal to the Frobenius Norm of the operation matrix designated as the verification value, and
completing certification for the first member when it is determined that the decryption value is equal to the Frobenius Norm of the operation matrix designated as the verification value.

9. The operating method of claim 6, further comprising:
maintaining a compensation information storage unit storing information on a payment amount of cryptocurrency corresponding to each of a plurality of different pre-designated reward reference scores, wherein the payment amount of cryptocurrency corresponding to each of the plurality of reward reference scores means a reward money pre-designated to be paid as a reward when the record score of the member reaches each reward reference score;
requesting, when it is confirmed that the first record score of the first member stored in the record score information storage unit reaches a first reward reference score which is any one of the plurality of reward reference scores, the first client terminal to transmit wallet address information for accumulating cryptocurrency;
confirming a first payment amount corresponding to the first reward reference score by referring to the reward information storage unit when first wallet address information is received from the first client terminal; and
transferring, when the first payment amount is confirmed, cryptocurrency corresponding to the first payment amount based on the first wallet address information to complete reward processing for the first member.

10. The operating method of claim 6, further comprising:
maintaining a price information storage unit storing purchase price information of the ticket for participating in the tournament;
requesting, when a purchase request command for requesting purchasing tickets corresponding to a first purchase quantity is received from the first client terminal, transmitting payment means information for cost payment;
calculating, when first payment means information is received from the first client terminal, a price corresponding to the first purchase quantity based on the purchase price information, and then performing cost payment processing for the calculated price based on the first payment means information; and
increasing, when the payment processing is completed, the quantity of holding tickets held by the first member stored in the ticket quantity information storage unit by the first purchase quantity.

11. A non-transitory computer readable recording medium having a program recorded therein for allowing a computer to execute an operating method of a service providing server for providing the game service that supports participation in a tournament for a game using a ticket and that gives the customized score according to the record about the member who participated in the tournament, comprising:
maintaining a ticket number information storage unit storing information on the number of required tickets for participating in tournaments of a plurality of predetermined respective games;
maintaining a game score information storage unit storing information on a predetermined game score corresponding to each of the plurality of games, wherein the game score of each of the plurality of games means a score given to a winner when winning a battle for each game;
maintaining a ticket quantity information storage unit storing information on the quantity of holding tickets held by each of a plurality of members which subscribes to the game service;
maintaining a record score information storage unit storing information on a record score corresponding to each of the plurality of members, wherein the record score of each of the plurality of members means a score calculated according to the game record of each member;
when an access request command to a tournament session, wherein the tournament session means a session opened for allowing members accessing the tournament session through the client terminal to play the first game online jointly, opened for a first game which is any one of the plurality of games is received from a first client terminal held by a first member which is any one of the plurality of members, conducting certification for the first member, and then confirming a first required number which is the number of required tickets for participating in the tournament of the first game by referring to the ticket number information storage unit, and confirming the quantity of holding tickets held by the first member by referring to the ticket quantity information storage unit;
allowing, when it is confirmed that the quantity of holding tickets held by the first member is equal to or more than the first required number, the first client terminal to access the tournament session, and then reducing the quantity of holding tickets held by the first member stored in the ticket quantity information storage unit by the first required number;
generating an update event for updating the record score when it is determined that the first member wins according to a result in which the first member matches a second member who accesses the tournament session, and performs the battle for the first game after the access of the first client terminal to the tournament session is permitted;
updating a first record score for the first member stored in the record score information storage unit based on a first game score corresponding to the first game stored in the game score information storage unit when the update event is generated; and
transmitting, when the first record score is updated, information on the updated first record score to the first client terminal.
